(19) United States
(12) Patent Application Publication
(10) Pub. No.: US 2024/0110620 A1
(43) Pub. Date: Apr. 4, 2024

(54) POWER TRANSMISSION DEVICE AND VEHICLE

(71) Applicant: HONDA MOTOR CO., LTD., Tokyo (JP)

(72) Inventor: Yoshimi Numazaki, Wako-shi (JP)

(21) Appl. No.: 17/955,673

(22) Filed: Sep. 29, 2022

(51) Int. Cl. F16H 57/027; F16H 57/04

(52) U.S. Cl. CPC F16H 57/027; F16H 57/0424; F16H 57/045

(57) ABSTRACT

[Problem to be Solved] The present invention is to provide a power transmission device and a vehicle that can prevent infiltration of oil into a breather chamber while increasing a degree of freedom of a mounting angle of the power transmission device with respect to a vehicle body.

[Means to Solve the Problem] A power transmission device 70 is configured to include a gear case 65, a final gear 74 rotatably provided in the gear case 65, an oil collection unit 100 configured to collect oil L scraped up by the final gear 74 in the gear case 65, an oil return flow channel portion 110 that returns the oil L collected by the oil collection unit 100 to a lower part in the gear case 65, and a breather chamber 120 that has a communication portion 125 for communicating with the oil return flow channel portion 110 and an outlet portion 126 that is formed on an upper part of the gear case 65 for communication between inside and outside of the gear case 65.

### BACKGROUND OF THE INVENTION

### Field of the Invention

The present invention relates to a power transmission device and a vehicle.

### Description of Related Art

A power transmission device transmits power emitted by a power unit such as an electric motor or an engine to vehicle wheels. Some power transmission devices have a gear case and a gear housed in the gear case. The gear shifts a rotation of an output shaft of the power unit and transmits it to an axle of a wheel. At the bottom of such a gear case, oil is housed for lubricating the gear and the like.

In Japanese Patent No. 3520654, it is disclosed that such a power transmission device is configured to include an oil collection unit (oil garter) that collects oil scraped up above a gear as the gear rotates, and an oil return passage that guides oil collected by the oil collection unit downward within a gear case.

### SUMMARY OF THE INVENTION

Incidentally, in the conventional technology as described above, an inclination of a bottom surface of the oil garter and a positional relationship between the oil garter and an inflow port of the oil return passage are set so that the oil naturally flows from the oil collection unit into the oil return passage by gravity. For this reason, with conventional technology, if a mounting angle of the power transmission device with respect to the vehicle body is changed, the oil may not easily flow from the oil collection unit to the oil return passage. Therefore, when one power transmission device is mounted on a plurality of vehicle types, it is desired to increase a degree of freedom in the mounting angle of the power transmission device with respect to the vehicle body.

In addition, in the conventional power transmission device, a breather is provided for communication between the inside and the outside of the gear case to adjust the pressure inside the gear case. The breather is often disposed in the upper part of the gear case where it communicates with the oil collection unit. However, there is a possibility that the scraped-up oil may intrude into the breather directly depending on the mounting angle of the power transmission device with respect to the vehicle body.

An aspect of the present invention has been made in view of the circumstances described above, and an object thereof is to provide a power transmission device and a vehicle that can prevent infiltration of oil into a breather chamber while increasing a degree of freedom in the mounting angle of the power transmission device with respect to a vehicle body.

In order to solve the problems described above, according to a first aspect of the present invention, there is provided a power transmission device including a gear case, a gear rotatably provided in the gear case, an oil collection unit configured to collect oil scraped up by the gear in the gear case, an oil return flow channel portion that returns the oil collected by the oil collection unit to a lower part in the gear case, and a breather chamber that has a communication portion for communicating with the oil return flow channel portion and an outlet portion that is formed on an upper part of the gear case for communication between inside and outside of the gear case.

According to a second aspect of the present invention, in the first aspect described above, the oil collection unit may be disposed in an upper part of the oil return flow channel portion in the gear case, and at least the upper part of the oil return flow channel portion may extend in a vertical direction.

According to a third aspect of the present invention, in the first aspect described above, a return port that returns the oil to the lower part in the gear case may be formed in a lower part of the oil return flow channel portion.

According to a fourth aspect of the present invention, in the third aspect described above, the communication portion may be disposed above the return port.

According to a fifth aspect of the present invention, in the fourth aspect described above, the communication portion may be disposed above an oil level of the oil in the gear case.

According to a sixth aspect of the present invention, in the first aspect described above, the oil return flow channel portion may be disposed along a side wall of the gear case.

According to a seventh aspect of the present invention, in the sixth aspect described above, the breather chamber may be disposed parallel to the oil return flow channel portion.

According to an eighth aspect of the present invention, in the first aspect described above, a first inner wall surface and a second inner wall surface facing each other in a direction intersecting an extending direction of the breather chamber connecting the communication portion and the outlet portion, and a plurality of protrusions protruding in the intersecting direction from the first inner wall surface and the second inner wall surface and alternately disposed at intervals in the extending direction may be included in the breather chamber.

According to a ninth aspect of the present invention, in the first aspect described above, a length of the breather chamber in the vertical direction may be greater than a width dimension in a direction intersecting the vertical direction.

According to a tenth aspect of the present invention, there is provided a vehicle including a vehicle main body, and a power transmission device according to the first aspect described above, which is mounted in the vehicle main body.

According to the first aspect of the present invention, the oil collected by the oil collection unit is returned to the lower part in the gear case through the oil return flow channel portion. In addition, the breather chamber for communication between the inside and outside of the gear case is linked from the communication portion that communicates with the oil return flow channel portion to an outlet portion that is formed in the upper part of the gear case. For this reason, the oil scraped up by the gear is prevented from directly intruding into the breather chamber, and the degree of freedom in mounting the power transmission device is increased. Therefore, it is possible to prevent a mounting angle of the power transmission device with respect to the vehicle body from being restricted. That is, it is possible to prevent the intrusion of the oil into the breather chamber while increasing the degree of freedom in the mounting angle of the power transmission device with respect to the vehicle body.

According to the second aspect of the present invention, since the oil collection unit is disposed in the upper part of the oil return flow channel portion, and at least the upper part of the oil return flow channel portion extends in the vertical direction, the oil collected by the oil collection unit smoothly flows into the oil return flow channel portion. As a result, the oil collected by the oil collection unit can be efficiently returned to the lower part in the gear case through the oil return flow channel portion.

According to the third aspect of the present invention, since the return port is formed in the lower part of the oil return flow channel portion, it is possible to reliably return the oil collected by the oil collection unit to the lower part in the gear case.

According to the fourth aspect of the present invention, the communication portion of the breather chamber is disposed above the return port, and thereby it is possible to prevent the oil in the gear case from flowing into the breather chamber even if the oil has intruded into the oil return flow channel portion from the return port.

According to the fifth aspect of the present invention, the communication portion of the breather chamber is disposed above the oil level of the oil in the gear case, and thereby, even when the oil in the gear case has intruded into the oil return flow channel portion from the return port, it is possible to prevent the oil level from reaching the communication portion and to prevent the oil from flowing into the breather chamber.

According to the sixth aspect of the present invention, the oil return flow channel portion is disposed along the side wall of the gear case, and thereby it is possible to easily include the oil return flow channel portion without changing the internal structure and disposition of the gear case.

According to the seventh aspect of the present invention, the breather chamber is disposed parallel to the oil return flow channel portion, and thereby it is possible to efficiently dispose the breather chamber and the oil return flow channel portion.

According to the eighth aspect of the present invention, a plurality of protrusions are alternately provided inside the breather chamber to form a labyrinth-shaped breather flow channel inside the breather chamber. As a result, even if gas containing oil mist flows into the breather chamber through the communication portion, it is possible to capture the oil by the plurality of protrusions to perform gas-liquid separation, and prevent the oil from leaking to the outside of the gear case.

According to the ninth aspect of the present invention, the length of the breather chamber in the vertical direction is greater than the width dimension, thereby ensuring a long flow path length in the breather chamber from the communication portion to the outlet portion. As a result, it is possible to retain more gas containing oil mist that has flowed in the oil return flow channel portion in the breather chamber for the gas-liquid separation, and to return the oil to the gear case.

According to the tenth aspect of the present invention, it is possible to provide a vehicle capable of preventing the intrusion of oil into a breather chamber while increasing a degree of freedom in the mounting angle of the power transmission device with respect to the vehicle body by providing a power transmission device as described above.

### BRIEF DESCRIPTION OF THE DRAWINGS

FIG. 1 is a left-side view of an electric three-wheel vehicle according to an embodiment of the present invention.

FIG. 2 is a perspective view which shows a power unit of the electric three-wheel vehicle described above.

FIG. 3 is a cross-sectional view at a position passing through centers of a motor output shaft, a counter shaft, and a left axle in a power transmission device of the electric three-wheel vehicle described above.

FIG. 4 is a right-side view of the power transmission device described above.

FIG. 5 is a left-side view of the power transmission device described above.

FIG. 6 is a cross-sectional view taken along a line of A-A of FIG. 5.

### DESCRIPTION OF EMBODIMENTS

Hereinafter, embodiments of the present invention will be described on the basis of drawings. In the drawings used below, an arrow FR indicates a front of a vehicle, an arrow UP indicates an upper side of the vehicle, and an arrow LH indicates a left side of the vehicle.

<Electric Three-Wheel Vehicle>

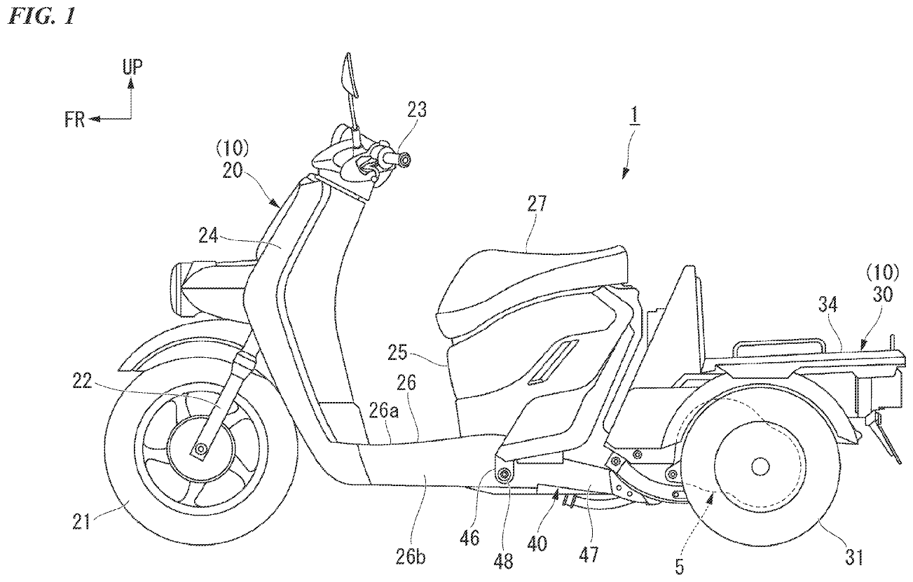

FIG. 1 is a left-side view of an electric three-wheel vehicle according to an embodiment of the present invention.

As shown in FIG. 1, an electric three-wheel vehicle (saddle-riding car) 1 includes a vehicle main body 10 and a power unit 5.

<Vehicle Main Body>

A vehicle main body 10 includes a front vehicle body 20, a rear vehicle body 30, and a swing mechanism 40. The front vehicle body 20 and the rear vehicle body 30 are connected via the swing mechanism 40. The front vehicle body 20 is connected to the rear vehicle body 30 by the swing mechanism 40 so that it can roll left and right.

The front vehicle body 20 includes front wheels 21, which are steering wheels. The front wheels 21 are supported by a pair of left and right front forks 22. The front wheels 21 can be steered by a bar handle 23. Steering system parts including the bar handles 23, the left and right front forks 22, and the front wheels 21 are supported by a front end of a front body frame (not shown) such that they can be steered.

A front part of the front vehicle body 20 is covered with a front cover 24. A rear part of the front vehicle body 20 is covered with a rear cover 25. A low floor part 26 is provided between the front cover 24 and the rear cover 25. A step floor 26a on which a driver's feet are placed is provided on an upper surface of the low floor part 26. A lower part of the low floor part 26 is covered with a pair of left and right floor side covers 26b that wrap around below left and right-side edges of the step floor 26a. A seat 27 on which passengers including the driver is seated is supported above the rear cover 25.

The rear vehicle body 30 has a pair of left and right rear wheels 31 that are driving wheels. The pair of left and right rear wheels 31 are driven by a power unit 5. The power unit 5 is supported by a rear body frame (not shown) that serves as a skeleton of the rear vehicle body 30. A load carrying tray 34 supported by a rear body frame (not shown) is provided above the power unit 5 and the left and right rear wheels 31.

A swing mechanism 40 has a link 46 and a damper section 47.

A link 46 is connected to a lower part of a front body frame of the front vehicle body 20 so that it can swing back and forth.

A front end of the damper section 47 is connected to a swing shaft 48 provided at a lower end of the link 46 so that it can swing. A rear body frame of the rear vehicle body 30 is attached to a rear end of the damper section 47. The damper section 47 includes a case provided on the link 46 side, a joint shaft member provided on the rear body frame side, and an elastic body provided between the case and the joint shaft member. In the damper section 47, when the front vehicle body 20 and the rear vehicle body 30 roll relatively, the case and the joint shaft member rotate relatively, and the elastic body is compressed in a circumferential direction to exert a damping action.

<Power Unit>

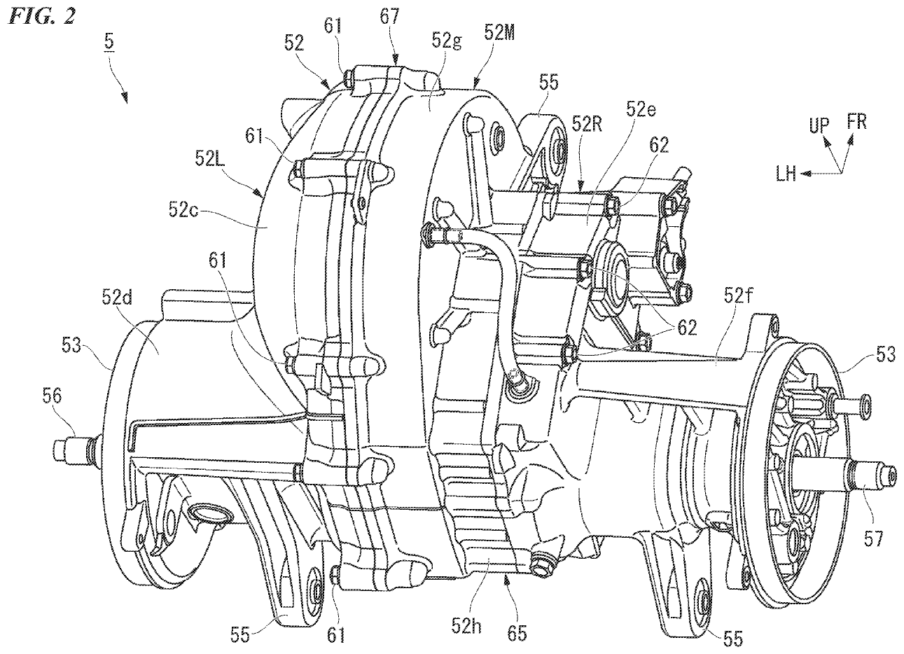

FIG. 2 is a perspective view which shows the power unit 5.

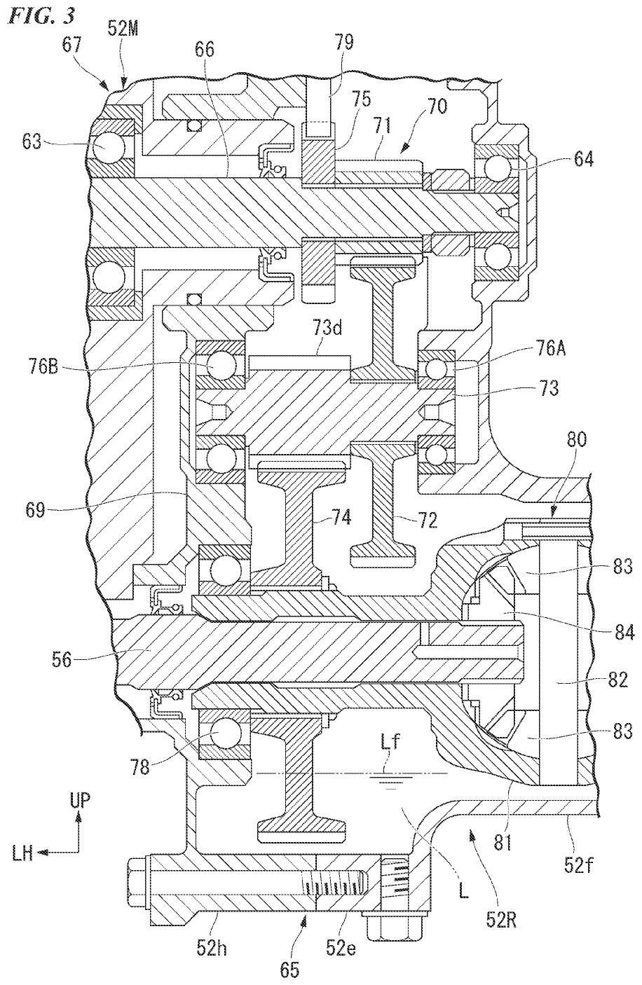

As shown in FIG. 2, the power unit 5 mainly includes a case 52, an electric motor (not shown), a power transmission device 70 (refer to FIG. 3), a pair of left and right brake devices 53, a left axle 56, and a right axle 57.

The case 52 includes a left case 52L, a right case 52R, and an inner case 52M.

The left case 52L integrally includes a left case bulging portion 52c and a left side extending portion 52d. The left case bulging portion 52c houses a portion of the electric motor. The left case bulging portion 52c bulges outward in a radial direction centering about the left axle 56 and the right axle 57 extending in a left and right direction with respect to the left side extending portion 52d. The left side extending portion 52d extends leftward from the left case bulging portion 52c.

The right case 52R integrally includes a right case bulging portion 52e and a right-side extending portion 52f extending rightward from the right case bulging portion 52e. The right case bulging portion 52e houses a power transmission device 70 and the like, which will be described below. The right case bulging portion 52e bulges outward in the radial direction centering about the left axle 56 and the right axle 57 with respect to the right-side extending portion 52f. The right-side extending portion 52f extends rightward from the right case bulging portion 52e.

The inner case 52M is disposed between the left case 52L and the right case 52R. The inner case 52M integrally includes a first inner case bulging portion 52g and a second inner case bulging portion 52h. The first inner case bulging portion 52g is disposed to a right of the left case bulging portion 52c. The first inner case bulging portion 52g houses a portion of the electric motor. The second inner case bulging portion 52h is disposed to a left of the right case bulging portion 52e. The second inner case bulging portion 52h houses the power transmission device 70 and the like, which will be described below.

The left case 52L and the inner case 52M are fastened with a plurality of bolts 61. The right case 52R and the inner case 52M are fastened with a plurality of bolts 62. The left case 52L, the right case 52R, and the inner case 52M each integrally include a supported arm portion 55 supported by a rear body frame (not shown).

The left case bulging portion 52c and the first inner case bulging portion 52g are laterally adjacent to each other to form a motor case 67 that houses an electric motor therein. The right case bulging portion 52e and the second inner case bulging portion 52h are laterally adjacent to each other to form a gear case 65 that houses various gears, shaft members, and the like therein.

FIG. 3 is a cross-sectional view at a position passing through centers of a motor output shaft 66, a counter shaft 73, and the left axle 56 in a power transmission device of an electric three-wheel vehicle 1.

The electric motor is housed in the motor case 67. The electric motor has a stator (not shown) fixed to the motor case 67 and a rotor (not shown) fixed to the motor output shaft 66 shown in FIG. 3. The motor output shaft 66 extends in the left and right direction. The motor output shaft 66 is rotatably supported by the motor case 67 via a pair of bearings 63 (only one bearing 63 is shown in FIG. 3).

The motor case 67 and the gear case 65 are partitioned by a partition wall 69 provided in the inner case 52M. The partition wall 69 is a side wall substantially orthogonal to an axial direction of the motor output shaft 66 and the like. The motor output shaft 66 penetrates the partition wall 69 and extends into the gear case 65. A tip portion of the motor output shaft 66 is rotatably supported by the gear case 65 via a bearing 64.

As shown in FIG. 2, a pair of left and right brake devices 53 are provided at both ends of the case 52. A pair of left and right brake devices 53 brake the left and right rear wheels 31 (refer to FIG. 1).

The left axle 56 and the right axle 57 each extend in the left and right direction. The left axle 56 and the right axle 57 are disposed on the same straight line extending in the left-right direction. The left axle 56 penetrates the brake device 53 and protrudes outward in a vehicle width direction from the left case 52L. The left axle 56 is rotatably supported by a bearing (not shown) provided in the left case 52L. The right axle 57 penetrates the brake device 53 and protrudes outward in the vehicle width direction from the right case 52R. The right axle 57 is rotatably supported by a bearing (not shown) provided in the right case 52R.

The left and right rear wheels 31 (refer to FIG. 1) are fixed to tip portions of the left axle 56 and the right axle 57. Left and right rear wheels 31 are braked by the brake devices 53 attached to the left case 52L and the right case 52R, respectively.

<Power Transmission Device>

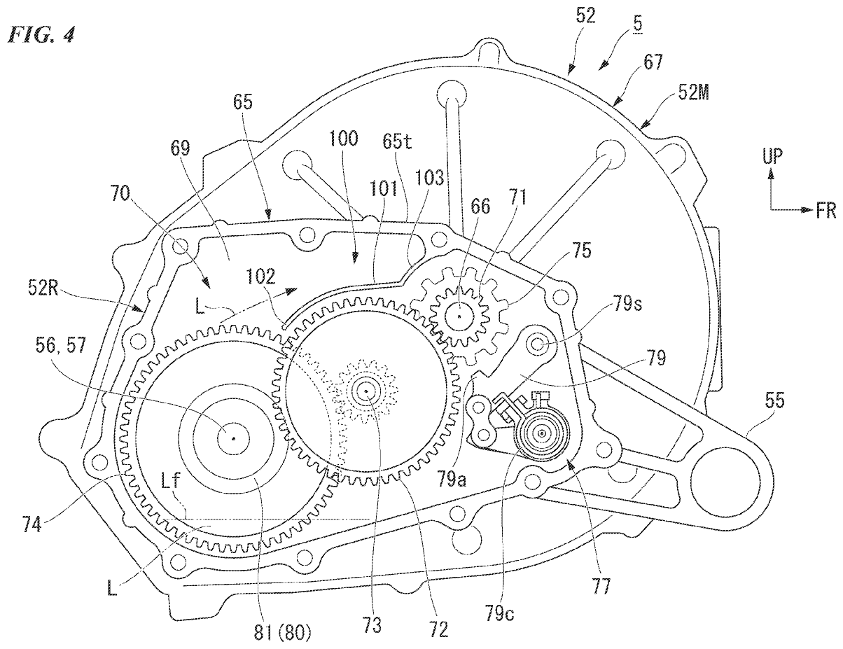

FIG. 4 is a right-side view of the power transmission device described above.

The power transmission device 70 transmits power generated by an electric motor (not shown) to the left axle 56 and the right axle 57. The power transmission device 70 is housed in the gear case 65.

As shown in FIGS. 3 and 4, the power transmission device 70 includes a drive gear 71, a counter gear 72, a counter shaft 73, a final gear (gear) 74, and a differential mechanism 80.

The drive gear 71 is spline-coupled to one end of the motor output shaft 66. A parking lock gear 75 is spline-coupled to one end of the motor output shaft 66 coaxially with the drive gear 71.

The counter shaft 73 extends in the left and right direction in parallel to the motor output shaft 66. The counter shaft 73 is rotatably supported by a bearing 76A provided on the right case 52R and a bearing 76B provided on the partition wall 69. The counter shaft 73 is integrally formed with a counter shaft gear 73d.

The counter gear 72 is spline coupled to the counter shaft 73. The counter gear 72 meshes with the drive gear 71.

The differential mechanism 80 includes a differential case 81, a pinion shaft 82, a pair of pinion gears 83, and a pair of side gears 84 (only one side gear 84 is shown in FIG. 3). The differential mechanism 80 allows a differential between the left and right rear wheels 31 (refer to FIG. 1).

A left end portion of the differential case 81 is rotatably supported by a bearing 78 provided on the partition wall 69. A right end portion of the differential case 81 is rotatably supported by a bearing (not shown) provided in the right case 52R.

The pinion shaft 82 is disposed in the differential case 81 so as to be orthogonal to the left and right direction. A pair of pinion gears 83 are rotatably supported by the pinion shaft 82 in the differential case 81. A pair of side gears 84 engage with the pair of pinion gears 83. A pair of side gears 84 are spline-coupled to inner ends of the left axle 56 and the right axle 57 in the vehicle width direction.

A final gear 74 is spline-coupled to the differential case 81. An outer peripheral portion of the final gear 74 engages with the counter shaft gear 73d.

As shown in FIG. 4, in such a power transmission device 70, the counter shaft 73 is disposed behind the motor output shaft 66. In addition, the left axle 56 and the right axle 57 are disposed behind the counter shaft 73. Moreover, the counter shaft 73 is disposed below the motor output shaft 66. The left axle 56 and the right axle 57 are disposed below the counter shaft 73. Also, the final gear 74 is formed to have a larger diameter than the counter gear 72.

The power unit 5 includes a parking lock mechanism 77. The parking lock mechanism 77 regulates a rotation of the motor output shaft 66 so that the left and right rear wheels 31 (refer to FIG. 1) do not rotate when the electric three-wheel vehicle 1 (refer to FIG. 1) is parked or stopped. The parking lock mechanism 77 includes a lock arm 79 and a parking lock gear 75.

The electric three-wheel vehicle 1 includes a parking lock operation portion (not shown) for operating the parking lock mechanism 77. The parking lock operation portion (not shown) consists of levers, pedals, or the like provided near the driver.

The lock arm 79 is provided so that it can swing around a swing shaft 79s provided on the right case 52R. The lock arm 79 is connected to the parking lock operation portion via an operation cable (not shown). The lock arm 79 swings around the swing shaft 79s when the parking lock operation portion is operated. The lock arm 79 is provided with a protrusion portion 79a.

The protrusion portion 79a of the lock arm 79 is normally separated from teeth of the parking lock gear 75 by a biasing force of the torsion coil spring 79c. When the driver operates the parking lock operation portion, the lock arm 79 swings via an operation cable. The protrusion portion 79a engages with the teeth of the parking lock gear 75, and thereby rotation of the parking lock gear 75 is restrained by the lock arm 79.

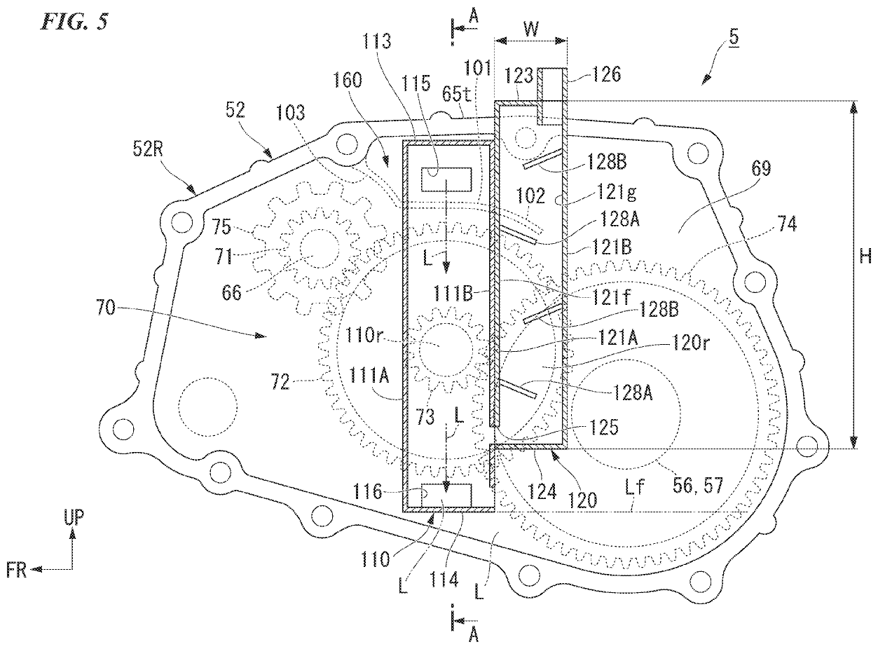

FIG. 5 is a left-side view of the power transmission device.

As shown in FIGS. 3 to 5, an oil L for lubricating is stored in a lower part in the gear case 65. At least a part of the final gear 74 disposed below the motor output shaft 66 and the counter shaft 73 is immersed in the oil L stored in the gear case 65. As a result, when the final gear 74 is driven to rotate by a rotation of the motor output shaft 66 driven to rotate by the electric motor, the oil L scraped up by the final gear 74 scatters in a tangential direction of an outer peripheral portion of the final gear 74 (refer to FIG. 4).

As shown in FIGS. 4 and 5, the power transmission device 70 has an oil collection unit 100 inside the gear case 65. The oil collection unit 100 collects the oil L scraped up by the final gear 74. The oil collection unit 100 is provided in an upper part inside the gear case 65.

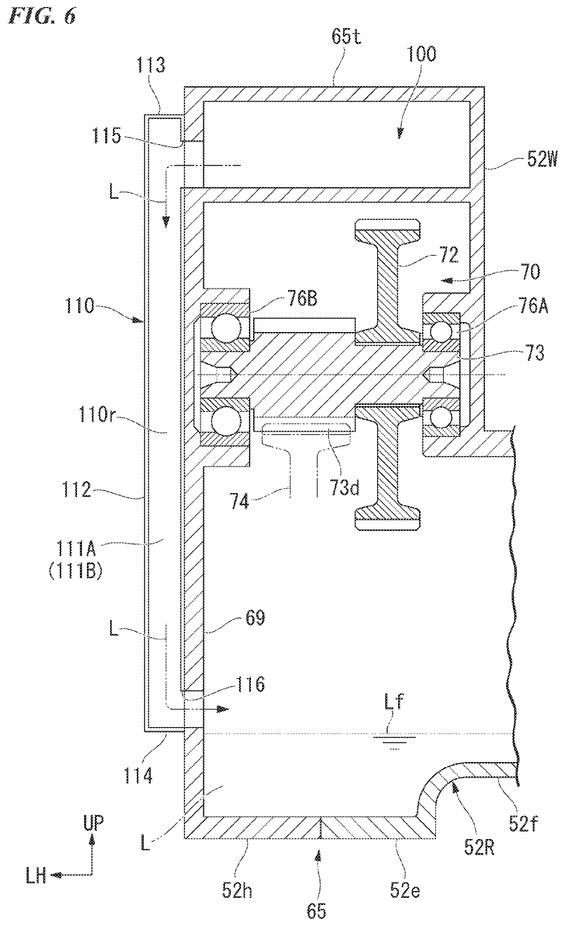

FIG. 6 is an A-A cross-sectional view of FIG. 5.

As shown in FIGS. 4 to 6, the oil collection unit 100 has a collection tray 101 below a upper wall portion 65t that forms an upper surface of the gear case 65. The collection tray 101 extends in the left and right direction between the partition wall 69 and a right wall portion 52w of the right case bulging portion 52e that is spaced rightward from the partition wall 69.

Behind the collection tray 101, a guide portion 102 extending obliquely downward toward an outer peripheral portion of the upper part of the rear final gear 74 is formed continuously from a rear end of the collection tray 101. A front wall portion 103 is provided in front of the collection tray 101, which is formed continuously from a front end of the collection tray 101, extends obliquely upward toward the front, and is connected to the upper wall portion 65t.

The oil L scraped up by the final gear 74 passes above the guide portion 102 and is received by the oil collection unit 100 surrounded by the collection tray 101, the front wall portion 103, and the upper wall portion 65t. Here, the oil L scraped up by the final gear 74 includes mist-type oil in addition to droplet-type oil.

As shown in FIG. 5, the power transmission device 70 further includes an oil return flow channel portion 110 and a breather chamber 120.

As shown in FIGS. 5 and 6, the oil return flow channel portion 110 returns the oil L collected by the oil collection unit 100 to the lower part in the gear case 65. The oil return flow channel portion 110 is disposed along the partition wall 69 of the gear case 65. At least an upper part of the oil return flow channel portion 110 extends in a vertical direction. In the present embodiment, the entire oil return flow channel portion 110 extends in the vertical direction.

The oil return flow channel portion 110 has a pair of side wall portions 111A and 111B, an opposing wall portion 112 (refer to FIG. 6), an upper part blocking portion 113, and a lower part blocking portion 114.

The pair of side wall portions 111A and 111B rise leftward from the partition wall (side wall) 69. The pair of side wall portions 111A and 111B are disposed with a predetermined interval in a front and rear direction. The pair of side wall portions 111A and 111B extend continuously in the vertical direction. The pair of side wall portions 111A and 111B are disposed in parallel to each other.

The opposing wall portion 112 (refer to FIG. 6) is spaced leftward from the partition wall 69. The opposing wall portion 112 is disposed in parallel to the partition wall 69. The opposing wall portion 112 is provided so as to block a space between the pair of side wall portions 111A and 111B from the left side.

The upper part blocking portion 113 is provided to block the space between the pair of side wall portions 111A and 111B from the above. The lower part blocking portion 114 is provided to block the space between the pair of side wall portions 111A and 111B from the below.

The oil return flow channel portion 110 is surrounded by the pair of side wall portions 111A and 111B, the partition wall 69, and the opposing wall portion 112 to form a flow path 110r extending in the vertical direction in a cylindrical shape. An upper part of the oil return flow channel portion 110 extends above the collection tray 101. A lowest part of the oil return flow channel portion 110 extends to a bottom portion of the gear case 65. The oil return flow channel portion 110 is formed such that the length in the vertical direction is greater than the width dimension in the front and rear direction.

The oil return flow channel portion 110 has an inlet port 115 and a return port 116. The inlet port 115 is formed in the upper part of the oil return flow channel portion 110. The inlet port 115 is formed to penetrate the partition wall 69 and communicate with the oil collection unit 100. The return port 116 is formed in the lowermost part of the oil return flow channel portion 110. The return port 116 is formed to penetrate the partition wall 69 and communicate with a bottom portion inside the gear case 65.

As shown in FIG. 5, the breather chamber 120 is provided along the partition wall 69. The breather chamber 120 is disposed rearwardly adjacent to the oil return flow channel portion 110. The breather chamber 120 extends vertically in parallel to the oil return flow channel portion 110. The breather chamber 120 is formed such that a length H in the vertical direction is greater than a width dimension W in the front and rear direction.

The breather chamber 120 has a pair of side wall portions 121A and 121B, an opposing wall portion (not shown), an upper part blocking portion 123, and a lower part blocking portion 124.

The pair of side wall portions 121A and 121B rise leftward from the partition wall 69. The pair of side wall portions 121A and 121B are disposed with a predetermined interval in the front and rear direction. The pair of side wall portions 121A and 121B extend continuously in the vertical direction. The opposing wall portion (not shown) is spaced leftward from the partition wall 69. The opposing wall portion is disposed in parallel to the partition wall 69. The opposing wall portion is provided to block a space between the pair of side wall portions 121A and 121B from the left side.

The upper part blocking portion 123 is provided to block the space between the pair of side wall portions 121A and 121B from the above. The lower part blocking portion 124 is provided to block the space between the pair of side wall portions 121A and 121B from the below.

The breather chamber 120 is surrounded by the pair of side wall portions 121A and 121B, the partition wall 69, and the opposing wall portion to form a breather flow channel 120r that extends in the vertical direction in a cylindrical shape.

An upper part of the breather chamber 120 extends to almost the same height as the upper wall portion 65t of the gear case 65. The lowest part of the breather chamber 120 is disposed above a bottom portion of the oil return flow channel portion 110 by a predetermined dimension.

The front side wall portion 121A of the breather chamber 120 and the rear side wall portion 111B of the oil return flow channel portion 110 are separate structures adjacent to each other, but may also be an integrated structure (a structure formed integrally) according to a manufacturing method of the gear case 65.

The breather chamber 120 has a communication portion 125 and an outlet portion 126.

The communication portion 125 is formed in a lower part of the breather chamber 120. The communication portion 125 penetrates the side wall portion 111B and the side wall portion 121A and communicates with the oil return flow channel portion 110. The communication portion 125 is disposed above the outlet portion 126. The communication portion 125 is disposed above an oil level Lf of the oil L in the gear case 65.

The outlet portion 126 is formed at a top of the breather chamber 120. The outlet portion 126 is formed in an upper part of the gear case 65. The outlet portion 126 is formed in a cylindrical shape extending in the vertical direction (or formed of a cylindrical body) to penetrate the upper wall portion 65t for communication between inside and outside of the gear case 65.

Inside the breather chamber 120, a plurality of protrusions 128A and 128B are provided. The plurality of protrusions 128A and 128B are provided on side wall portions 121A and 121B facing each other in the front and rear direction. The side wall portions 121A and 121B face each other in a direction (the front and rear direction) that intersects an extending direction (the vertical direction) of the breather chamber 120 connecting the communication portion 125 and the outlet portion 126.

The protrusion 128A extends obliquely downward toward the rear from a first inner wall surface 121f facing the rear in the side wall portion 121A. A plurality of protrusions 128A are provided at intervals in the vertical direction. The protrusion 128B extends obliquely downward toward the front from a second inner wall surface 121g facing the front in the side wall portion 121B. A plurality of protrusions 128B are provided at intervals in the vertical direction. The protrusion 128B is disposed at different positions in the vertical direction with respect to the protrusion 128A.

The plurality of protrusions 128A and 128B are alternately provided with an interval in the vertical direction. By providing the plurality of protrusions 128A and 128B inside the breather chamber 120, the breather flow channel 120r in the breather chamber 120 is formed in a labyrinth shape.

By providing the oil collection unit 100, the oil return flow channel portion 110, and the breather chamber 120, the oil L collected by the oil collection unit 100 passes through a flow path 110r of the oil return flow channel portion 110 from the inlet port 115 and is returned from the return port 116 to the lower part in the gear case 65.

In addition, a flow of gas (air) in the gear case 65 caused by pressure fluctuations generated in the gear case 65 can flow out from the outlet portion 126 to the outside of the gear case 65 via the breather chamber 120 from the oil return flow channel portion 110. Gas that flows into the breather chamber 120 from the oil return flow channel portion 110 through the communication portion 125 contains mist or the like of the oil L. The mist of the oil L comes into contact with the plurality of protrusions 128A and 128B, and thereby it is captured by the plurality of protrusions 128A and 128B and is separated into gas and liquid. As a result, an oil content from the gas flowing out from the outlet portion 126 is removed. Oil separated in the breather chamber 120 is returned to the return port 116 from the communication portion 125.

As described above, according to the power transmission device 70 and the electric three-wheel vehicle 1, the oil L collected by the oil collection unit 100 is returned to the lower part in the gear case 65 through the oil return flow channel portion 110. The breather chamber 120 that adjusts a pressure inside the gear case 65 is linked from the communication portion 125 that communicates with the oil return flow channel portion 110 to an outlet portion 126 that is formed in the upper part of the gear case 65. For this reason, the oil L scraped up by the final gear 74 is prevented from directly intruding into the breather chamber 120, and the degree of freedom in mounting the power transmission device 70 is increased. Therefore, it is possible to prevent a mounting angle of the power transmission device 70 with respect to the vehicle body from being restricted. That is, it is possible to prevent the intrusion of the oil L into the breather chamber 120 while increasing the degree of freedom in the mounting angle of the power transmission device 70 with respect to the vehicle body.

In addition, since the oil collection unit 100 is disposed in the upper part of the oil return flow channel portion 110, and at least the upper part of the oil return flow channel portion 110 extends in the vertical direction, the oil L collected by the oil collection unit 100 flows smoothly into the oil return flow channel portion 110. As a result, the oil L collected by the oil collection unit 100 can efficiently return to the lower part in the gear case 65 through the oil return flow channel portion 110.

In addition, the return port 116 is formed in the lowest part of the oil return flow channel portion 110, and thereby the oil L collected by the oil collection unit 100 can reliably return to the lower part in the gear case 65.

In addition, the communication portion 125 of the breather chamber 120 is disposed above the return port 116, and thereby it is possible to prevent the oil L from flowing into the breather chamber 120 through the communication portion 125 even when the oil L in the gear case 65 has intruded into the oil return flow channel portion 110 from the return port 116.

Moreover, the communication portion 125 of the breather chamber 120 is disposed above the oil level Lf of the oil L in the gear case 65. As a result, even when the oil L in the gear case 65 has intruded into the oil return flow channel portion 110 from the return port 116, it is possible to prevent the oil level Lf from reaching the communication portion 125, and to prevent the oil L from flowing into the breather chamber 120.

In addition, the oil return flow channel portion 110 is disposed along the partition wall 69 of the gear case 65, and thereby it is possible to easily include the oil return flow channel portion 110 without changing an internal structure and disposition of the gear case 65.

In addition, by disposing the breather chamber 120 parallel to the oil return flow channel portion 110, the breather chamber 120 and the oil return flow channel portion 110 can be disposed efficiently. In addition, a flow in the oil return flow channel portion 110 is from the top to the bottom, while a flow in the breather chamber 120 is from the bottom to the top. As a result, even when gas that has flowed into the breather chamber 120 from the communication portion 125 contains the mist or the like of the oil L, it is possible to prevent the oil L from reaching the outlet portion 126.

In addition, a plurality of protrusions 128A and 128B are alternately provided inside the breather chamber 120, and thereby a labyrinth-shaped breather flow channel 120r is formed inside the breather chamber 120. As a result, even if a gas containing the mist or the like of the oil L flows into the breather chamber 120 through the communication portion 125, it is possible to capture the oil L by the plurality of protrusions 128A and 128B to perform gas-liquid separation, and to prevent the oil L from leaking to the outside of the gear case 65.

In addition, since the length H of the breather chamber 120 in the vertical direction is greater than the width dimension W, it is possible to ensure a long flow path length in the breather chamber 120 from the communication portion 125 to the outlet portion 126, to retain more gas containing the mist or the like of the oil L that has flowed into the oil return flow channel portion 110 to perform gas-liquid separation, and to return the oil L to the inside of the gear case 65.

Note that the present invention is not limited to the embodiments described above with reference to the drawings, and various modifications are conceivable within the technical scope.

For example, the oil return flow channel portion 110 and the breather chamber 120 are provided along the partition wall 69 positioned on the left side of the gear case 65, but the present invention is not limited thereto. The oil return flow channel portion 110 and the breather chamber 120 may be provided along a wall positioned at the right side of the gear case 65.

In addition, the saddle type vehicle includes all vehicles in which the driver straddles the vehicle body, not limited to tricycles with one front wheel and two rear wheels, tricycles with two front wheels and one rear wheel, motorcycles (including motorized bicycles and scooter-type vehicles), or four-wheeled vehicles, and also includes vehicles equipped with an internal combustion engine instead of an electric motor as a power unit.

It may be applied to vehicles other than saddle-riding vehicles (passenger cars, buses, trucks, and the like).

The configuration in the embodiment described above is an example of the present invention, and various modifications are possible within a range not departing from the gist of the invention.

### BRIEF DESCRIPTION OF THE REFERENCE SYMBOLS

1: Electric three-wheel vehicle (Saddle-riding vehicle)
10: Vehicle main body
56: Left axle
57: Right axle
65: Gear case
66: Motor output shaft
67: Motor case
69: Partition wall (Side wall)
70: Power transmission device
71: Drive gear
72: Counter gear
73: Counter axis
74: Final gear (Gear)
100: Oil collection unit
110: Oil return flow channel portion
110r: Flow path
116: Return port
120: Breather chamber
121f: First inner wall surface
121g: Second inner wall surface
125: Communication portion
126: Outlet portion
128A, 128B: Protrusion
L: Oil
Lf: Oil level
H: Length
W: Width dimension

1. A power transmission device comprising:
a gear case;
a gear rotatably provided in the gear case;
an oil collection unit configured to collect oil scraped up by the gear in the gear case;
an oil return flow channel portion that returns the oil collected by the oil collection unit to a lower part in the gear case; and
a breather chamber that has a communication portion for communicating with the oil return flow channel portion and an outlet portion that is formed on an upper part of the gear case for communication between inside and outside of the gear case,
wherein
the oil collection unit is disposed in an upper part of the oil return flow channel portion in the gear case,
at least the upper part of the oil return flow channel portion extends in a vertical direction,
a first inner wall surface and a second inner wall surface face each other in a direction intersecting an extending direction of the breather chamber connecting the communication portion and the outlet portion, and a plurality of protrusions protruding in the intersecting direction from the first inner wall surface and the second inner wall surface and alternately disposed at intervals in the extending direction are included in the breather chamber,
first protrusions extend obliquely downward toward a rear from the first inner wall surface,
second protrusions extend obliquely downward toward a front from the second inner wall surface,
the second protrusions are disposed at different positions in the extending direction with respect to the first protrusions, and
a breather flow channel in the breather chamber is formed in a labyrinth shape.

2. (canceled)

3. The power transmission device according to claim 1,
wherein a return port that returns the oil to the lower part in the gear case is formed in a lower part of the oil return flow channel portion.

4. The power transmission device according to claim 3,
wherein the communication portion is disposed above the return port.

5. The power transmission device according to claim 4,
wherein the communication portion is disposed above an oil level of the oil in the gear case.

6. The power transmission device according to claim 1,
wherein the oil return flow channel portion is disposed along a side wall of the gear case.

7. The power transmission device according to claim 6,
wherein the breather chamber is disposed parallel to the oil return flow channel portion.

8. (canceled)

9. The power transmission device according to claim 1,
wherein a length of the breather chamber in a vertical direction is greater than a width dimension in a direction intersecting the vertical direction.

10. A vehicle comprising:
a vehicle main body; and
a power transmission device according to claim 1, which is mounted in the vehicle main body.
